(19) United States
(12) Patent Application Publication
(10) Pub. No.: US 2022/0056174 A1
(43) Pub. Date: Feb. 24, 2022

(54) PROCESS FOR THE PREPARATION OF A COLORED POLYPROPYLENE

(71) Applicant: BASELL POLIOLEFINE ITALIA S.R.L., MILANO (IT)

(72) Inventors: DIEGO BRITA, FERRARA (IT); CLAUDIO CAVALIERI, FERRARA (IT)

(73) Assignee: BASELL POLIOLEFINE ITALIA S.R.L., MILANO (IT)

(21) Appl. No.: 17/298,812

(22) PCT Filed: Nov. 26, 2019
(86) PCT No.: PCT/EP2019/082595

§ 371 Date: Jun. 1, 2021

(30) Foreign Application Priority Data
Dec. 4, 2018 (EP) 18210162.6

(51) Int. Cl. C08F 110/06; C08F 2/44; C08F 4/646; C08F 4/651; C08F 4/654; C08K 3/04; C08K 3/013; C08K 5/00

(52) U.S. Cl. CPC C08F 110/06; C08F 2/44; C08F 4/6465; C08F 4/651; C08F 2410/01; C08K 3/04; C08K 3/013; C08K 5/0041; C08F 4/6545

(57) ABSTRACT

A process for the preparation of a propylene polymer containing a coloring agent in an amount ranging from 0.2 to 30 ppm referred to the weight of propylene polymer, including the steps of: a) providing a solid ZN catalyst component made from or containing Mg, Ti, halogen and an internal electron donor compound, wherein the Ti being in an amount ranging from 0.1 to 10% of the total weight of solid catalyst component; b) providing a coloring agent made from or containing at least a pigment; c) mixing the ZN catalyst particles and the coloring agent in a liquid hydrocarbon medium, thereby obtaining a slurry and d) feeding the slurry to a polymerization reactor and subjecting the reactor to polymerization conditions, thereby yielding the propylene polymer.

### FIELD OF THE INVENTION

In general, the present disclosure relates to the field of chemistry. More specifically, the present disclosure relates to polymer chemistry. In particular, the present disclosure relates to a polymerization process for the preparation of a propylene polymer made from or containing colored compounds.

### BACKGROUND OF THE INVENTION

In some instances, polyolefins are prepared into articles, using an additive package. In some instances, the additive package is made from or containing stabilizers, clarifying agents to increase transparency, and coloring agents to increase or lower the intensity of color.

In some instances, the additive package is added in the form of an “additive package” pre-blend, further made from or containing antioxidants, acid scavengers, slip agents, light stabilizers, optical brighteners or UV light absorbers.

In some instances, the coloring agent is in the form of a masterbatch pre-mixed with polymer. Sometimes, the coloring agent is added during or just prior to the forming process. In some instances, a relatively high colorant loading of 500-1000 parts per million (ppm) is mixed and dispersed into a plastic in this manner.

In some instances, dispersing an additive into a polymer at very low loading levels of additive is made through several steps of successive dilutions. In some instances, a very low loading level of additive is in the range of a few ppm.

### SUMMARY OF THE INVENTION

In a general embodiment, the present disclosure provides a process for the preparation of a propylene polymer containing a coloring agent in an amount ranging from 0.2 to 30 ppm referred to the weight of propylene polymer, including the steps of: a) providing a solid ZN catalyst component made from or containing Mg, Ti, halogen and an internal electron donor compound, wherein the Ti being in an amount ranging from 0.1 to 10% of the total weight of solid catalyst component; b) providing a coloring agent made from or containing at least a pigment; c) mixing the ZN catalyst particles and the coloring agent in a liquid hydrocarbon medium, thereby obtaining a slurry; and d) feeding the slurry to a polymerization reactor and subjecting the reactor to polymerization conditions, thereby yielding the propylene polymer.

In some embodiments, the ZN solid catalyst component in step a) is of granular, spheroidal irregular or spherical regular morphology.

In some embodiments, the granular or otherwise irregular catalyst particle is obtained by reacting Ti-halides with precursors of the formula MgXₙ(OR)₂₋ₙ wherein X is Cl or a C₁-C₁₀ hydrocarbon group, R is a C₁-C₈ alkyl group and n ranges from 0 to 2. In some embodiments, a reaction generates solid particles made of or containing MgCl₂ on which a Ti compound is fixed.

In some embodiments, catalyst components having a regular morphology are obtained by reacting Ti-halides with precursors made from or containing adducts of formula MgCl₂(R¹OH)ₙ where IV is a C₁-C₈ alkyl group, alternatively ethyl, and n is from 2 to 6.

In some embodiments, the amount of Mg in the solid catalyst component ranges from 8 to 30% by weight, alternatively from 10 to 25% wt, with respect to the total weight of solid catalyst component.

In some embodiments, the amount of Ti ranges from 0.5 to 8% by weight, alternatively from 0.7 to 5% wt, alternatively from 1 to 3.5% wt, with respect to the total weight of solid catalyst component.

In some embodiments, the titanium atoms are part of titanium compounds of formula Ti(OR²)ₙX₄₋ₙ wherein n is between 0 and 4; X is halogen and R² is a hydrocarbon radical, alternatively alkyl, radical having 1-10 carbon atoms. In some embodiments, the titanium compounds have at least one Ti-halogen bond such as titanium tetrahalides or halogen alcoholates. In some embodiments, the titanium compounds are selected from the group consisting of TiCl₄ and Ti(OEt)Cl₃.

In some embodiments, the catalyst component is further made from or containing an electron donor compound (internal donor). In some embodiments, the electron donor compound is selected from esters, ethers, amines, silanes, carbamates and ketones or mixtures thereof.

In some embodiments, the internal donor is selected from the group consisting of alkyl and aryl esters of optionally substituted aromatic mono or polycarboxylic acids and esters of aliphatic acids selected from the group consisting of malonic, glutaric, maleic and succinic acids. In some embodiments, the esters of optionally substituted aromatic mono or polycarboxylic acids are selected from the group consisting of esters of benzoic and phthalic acids. In some embodiments, the internal donors are esters selected from the group consisting of n-butylphthalate, di-isobutylphthalate, di-n-octylphthalate, ethyl-benzoate and p-ethoxy ethyl-benzoate. In some embodiments, the internal donors are selected from the diesters described in Patent Cooperation Treaty Publication No. WO2010/078494 and U.S. Pat. No. 7,388,061. In some embodiments, the internal donors are selected from 2,4-pentanediol dibenzoate derivatives and 3-methyl-5-t-butyl catechol dibenzoates. In some embodiments, the internal donor is a diol derivative selected from the group consisting of dicarbamates, monoesters monocarbamates and monoesters monocarbonates. In some embodiments, the internal donors are selected from the group consisting of 1,3 diethers of the formula:

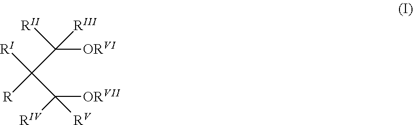

wherein R, R^{I}, R^{II}, R^{III}, R^{IV} and R^{V} equal or different to each other, are hydrogen or hydrocarbon radicals having from 1 to 18 carbon atoms, and R^{VI} and R^{VII}, equal or different from each other, have the same meaning of R-R^{V} except that R^{VI} and R^{VII} cannot be hydrogen. In some embodiments, one or more of the R-R^{VII} groups are linked to form a cycle. In some embodiments, the 1,3-diethers have R^{VI} and R^{VII} selected from C₁-C₄ alkyl radicals.

In some embodiments, mixtures of the donors are used. In some embodiments, the mixtures are made from or containing esters of succinic acids and 1,3-diethers as described in Patent Cooperation Treaty Publication No. WO2011/061134.

In some embodiments, the internal donors are selected from the group consisting of 1,3 diethers of the formula:

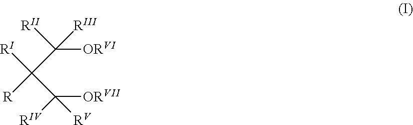

where R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups cannot be hydrogen. In some embodiments, the C₁-C₁₈ hydrocarbon groups of R^{I} and R^{IV} form one or more cyclic structures. In some embodiments, each of R^{I} to R^{IV} groups contain heteroatoms selected from halogens, N, O, S and Si.

In some embodiments, the final amount of electron donor compound in the solid catalyst component ranges from 0.5 to 30% by weight, alternatively from 1 to 20% by weight.

In some embodiments, the preparation of the solid catalyst component includes the reaction between magnesium alcoholates or chloroalcoholates and an excess of TiCl₄ in the presence of the electron donor compounds at a temperature of about 80 to 120° C. In some embodiments, the chloroalcoholates are prepared according to U.S. Pat. No. 4,220,554.

In some embodiments, the solid catalyst component is prepared by reacting a titanium compound of formula Ti(OR²)m-yXy, where m is the valence of titanium and y is a number between 1 and m and R² has the same meaning as previously disclosed herein, with a magnesium chloride deriving from an adduct of formula MgCl₂.pR³OH, where p is a number between 0.1 and 6, alternatively from 2 to 3.5, and R³ is a hydrocarbon radical having 1-18 carbon atoms. In some embodiments, the titanium compound is TiCl₄. In some embodiments, the adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (at a temperature in a range of about 80-130° C.), thereby obtaining an adduct in which the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130° C. and kept at this temperature for 0.5-2 hours. In some embodiments, the temperature of the cold TiCl₄ is about 0° C. In some embodiments, the treatment with TiCl₄ is carried out one or more times. In some embodiments, the electron donor compound is added during the treatment with TiCl₄. In some embodiments, the preparation of catalyst components in spherical form occurs as described in European Patent Applications EP-A-395083, EP-A-553805, EP-A-553806, EP-A-601525 or Patent Cooperation Treaty Publication No. WO98/44009.

In some embodiments, the coloring agent of step b) is made from or containing at least one hydrocarbon insoluble pigment. In some embodiments, the coloring agent is a mixture made from or containing a dye. In some embodiments, the coloring agent is made from or containing a dye in combination with one or more pigments.

In some embodiments, the pigment is either organic or inorganic. As described herein, an organic pigment contains at least a C—H bond. Conversely and as described herein, an inorganic pigment does not contain C—H bonds.

In some embodiments, pigments are black or blue.

In some embodiments, pigments are based on Carbon Black, phthalocyanine metal derivatives, Ultramarine Blue (inorganic), or quinacridone based pigments. In some embodiments, the carbon black is Cabot Black. In some embodiments, the phthalocyanine metal derivative is Cu-Phthalocyanine.

In some embodiments, the coloring agent is used in step (a) in amount such that the weight ratio coloring agent of step b)/catalyst component of step a) ranges from 0.005 to 5, alternatively from 0.008 to 4, alternatively from 0.01 to 2.5.

In some embodiments, the solid catalyst component of step a) and the coloring agent of step b) are contacted with a liquid inert hydrocarbon at a temperature below about 60° C., alternatively from about 0 to 30° C. In some embodiments, the liquid inert hydrocarbon is propane, n-hexane or n-heptane. In some embodiments, the slurry mixture is stored for several days or months. In some embodiments, the slurry is stored from about six seconds to 60 hours, alternatively from 1 hour to 40 hours.

The slurry is then contacted with an alkyl-Al compound before being introduced into the polymerization reactor. In some embodiments, the slurry is then contacted with an alkyl-Al compound and an external electron donor compound before being introduced into the polymerization reactor.

In some embodiments, the alkyl-Al compound, which is a co-catalyst activator, is is a trialkyl aluminum compound. In some embodiments, the trialkyl aluminum compound is selected from the group consisting of triethylaluminum, tri-n-hexylaluminum, and tri-n-octylaluminum. In some embodiments, the alkyl-Al compound is selected from mixtures of trialkylaluminums with alkylaluminum halides, alkylaluminum hydrides or alkylaluminum sesquichlorides. In some embodiments, the alkylaluminum sesquichlorides is AlEt₂Cl or Al₂Et₃Cl₃.

In some embodiments, the external electron-donor compounds are selected from the group consisting of silicon compounds, ethers, esters, amines, heterocyclic compounds, ketones and the 1,3-diethers. In some embodiments, the ester is ethyl 4-ethoxybenzoate. In some embodiments, the heterocyclic compound is 2,2,6,6-tetramethyl piperidine. In some embodiments, the external donor compounds are silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. In some embodiments, the external electron-donor compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane and 1,1,1,trifluoropropyl-methyl-dimethoxysilane. In some embodiments, the external electron donor compound is used in an amount to give a molar ratio between the organo-aluminum compound and the electron donor compound of from 5 to 500, alternatively from 7 to 400, alternatively from 10 to 200.

In some embodiments, the solid catalyst component of step a), the coloring agent of step b), the alkyl-Al compound and the external donor (if present) components are contacted in a single step in the presence of the liquid inert hydrocarbon. In some embodiments, the liquid inert hydrocarbon is propane, n-hexane or n-heptane. In some embodiments, the amounts of alkyl-Al provide a weight ratio with the solid catalyst component of step a) in the range of 0.1-10. In some embodiments, the external donor is present and the molar ratio alkyl-Al/external donor is from 5 to 500, alternatively from 7 to 400, alternatively from 10 to 200. In some embodiments, the components are pre-contacted at a temperature of from 10 to 20° C. for 1-30 minutes. In some embodiments, the pre-contact vessel is either a stirred tank or a loop reactor.

The precontacted catalyst is then fed to the polymerization reactor according to step d). In some embodiments, before being subjected to the main polymerization stage, the catalyst/coloring agent mixture coming from the precontact, is fed to a pre-polymerization reactor. The prepolymerization step is carried out in a first reactor selected from a loop reactor or a continuously stirred tank reactor. In some embodiments, the prepolymerization is carried out either in gas-phase or in liquid-phase. In some embodiments, the prepolymerization is carried out in liquid-phase. The liquid medium is made from or contains liquid alpha-olefin monomer(s), optionally with the addition of an inert hydrocarbon solvent. In some embodiments, the hydrocarbon solvent is aromatic or aliphatic. In some embodiments, the aromatic hydrocarbon solvent is toluene. In some embodiments, the aliphatic hydrocarbon solvent is selected from the group consisting of propane, hexane, heptane, isobutane, cyclohexane and 2,2,4-trimethylpentane. In some embodiments, the amount of hydrocarbon solvent is lower than 40% by weight with respect to the total amount of alpha-olefins, alternatively lower than 20% by weight. In some embodiments, the pre-polymerization step is carried out in the absence of inert hydrocarbon solvents.

In some embodiments, the average residence time in the reactor ranges from 2 to 40 minutes, alternatively from 10 to 25 minutes. In some embodiments, the temperature is between 10° C. and 50° C., alternatively between 20° C. and 40° C. In some embodiments, the pre-polymerization degree is in the range from 60 to 800 g per gram of solid catalyst component, alternatively from 150 to 500 g per gram of solid catalyst component.

The slurry containing the prepolymerized catalyst is discharged from the pre-polymerization reactor and fed to the reactor where step (d) takes place.

In some embodiments, the main polymerization stage is carried out in gas-phase or in liquid phase. In some embodiments, the gas-phase process is carried out in a fluidized or stirred, fixed bed reactor or in a gas-phase reactor having two interconnected polymerization zones. The first polymerization zone works under fast fluidization conditions. The second polymerization zone has the polymer flows under the action of gravity. In some embodiments, the liquid phase process is in slurry, solution or bulk (liquid monomer). In some embodiments, the liquid phase process is carried out in continuous stirred tank reactors, loop reactors or plug-flow reactors. In some embodiments, the polymerization is carried out at temperature of from 20 to 120° C., alternatively from 40 to 85° C. In some embodiments, the polymerization is carried out in gas-phase and the operating pressure is between 0.5 and 10 MPa, alternatively between 1 and 5 MPa. In some embodiments, the polymerization is carried out in bulk polymerization and the operating pressure is between 1 and 6 MPa, alternatively between 1.5 and 4 MPa. In some embodiments, the main polymerization stage is carried out by polymerizing in liquid monomer, propylene, optionally in mixture with ethylene and/or C₄-C₁₀ alpha olefins, thereby obtaining crystalline propylene polymer. In some embodiments, the reactor is a loop reactor.

In some embodiments, hydrogen is used as a molecular weight regulator. In some embodiments, the propylene polymer obtained in this stage has a xylene insolubility higher than 90%, alternatively higher than 95%, an isotactic index in terms of content of isotactic pentads (determined with C13-NMR on the whole polymer) higher than 93%, alternatively higher than 95%. In some embodiments, the Melt Flow Rate value according to ISO 1133 (230° C., 2.16 Kg) varies within a wide range going from 0.01 to 300 g/10 min, alternatively from 0.1 to 250 g/10 min.

In case of production of heterophasic propylene copolymers (also called impact copolymers), a second polymerization stage in a different reactor is carried out for the preparation of a propylene/ethylene copolymer. In some embodiments, the second stage is carried out in a fluidized-bed gas-phase reactor in the presence of the polymeric material and the catalyst system coming from the preceding polymerization step. The polymerization mixture is discharged from the first reactor to a gas-solid separator, and subsequently fed to the fluidized-bed gas-phase reactor.

In some embodiments, the polymer produced in this second stage is an ethylene copolymer containing from 15 to 75% wt of a C₃-C₁₀ alpha olefin, optionally containing minor proportions of a diene, being for at least 60% soluble in xylene at room temperature. In some embodiments, the alpha olefin is selected from propylene or butene-1. In some embodiments, the alpha olefin content ranges from 20 to 70% wt.

In some embodiments, the final propylene polymer is obtained as reactor grade with a Melt Flow Rate value according to ISO 1133 (230° C., 2.16 Kg) ranging from 0.01 to 100 g/10 min, alternatively from 0.1 to 70, alternatively from 0.2 to 60. In some embodiments, the final propylene polymer is chemically degraded, thereby achieving the final MFR value.

In some embodiments, the propylene polymers are characterized by an amount of coloring agent ranging from 0.2 to 30, alternatively from 0.3 to 28 ppm, alternatively from 0.3 to 25 ppm, referred to the weight of propylene polymer.

In some embodiments, the yellowness index of the polymer is reduced with respect to the yellowness index of the polymer not containing the coloring agent, thereby demonstrating an improved visual appearance. In some embodiments, the reduction of yellowness index is obtained in combination with a catalyst activity. In some embodiments, the catalyst activity remains at the same level.

In some embodiments, the propylene polymers are further made from or containing additives. In some embodiments, the additives are selected from the group consisting of antioxidants, light stabilizers, heat stabilizers, nucleating agents and fillers.

In some embodiments, the addition of nucleating agents improves physical-mechanical properties. In some embodiments, the improved physical-mechanical properties are selected from the group consisting of Flexural Modulus, Heat Distortion Temperature (HDT), tensile strength at yield and transparency.

In some embodiments, the nucleating agents are selected from the group consisting of p-tert.-butyl benzoate and the 1,3- and 2,4-dibenzylidenesorbitols.

In some embodiments, the nucleating agents are added to the compositions in quantities ranging from 0.05 to 2% by weight, alternatively from 0.1 to 1% by weight, with respect to the total weight.

In some embodiments, the additives are inorganic fillers. In some embodiments, the inorganic fillers are selected from the group consisting of talc, calcium carbonate and mineral fibers. In some embodiments, the inorganic fillers improve mechanical properties. In some embodiments, the mechanical properties are selected from the group consisting of flexural modulus and HDT. In some embodiments, the inorganic filler is talc.

### EXAMPLES

The data of the propylene polymer materials were obtained according to the following methods:

### Xylene-Soluble Faction

2.5 g of polymer and 250 mL of o-xylene were introduced into a glass flask equipped with a refrigerator and a magnetic stirrer. The temperature was raised in 30 minutes up to the boiling point of the solvent. The resulting solution was then kept under reflux and stirring for further 30 minutes. The closed flask was then kept for 30 minutes in a bath of ice and water and in thermostatic water bath at 25° C. for 30 minutes as well. The resulting solid was filtered on quick filtering paper, and the filtered liquid was divided into two 100 ml aliquots. One 100 ml aliquot of the filtered liquid was poured in a pre-weighed aluminum container, which was heated on a heating plate under nitrogen flow, to remove the solvent by evaporation. The container was then kept in an oven at 80° C. under vacuum until a constant weight was obtained. The residue was weighed to determine the percentage of xylene-soluble polymer.

### Melt Flow Rate (MFR)

Determined according to ISO 1133 (230° C., 2.16 Kg)

### Yellowness Index

The determination of the yellowness index (YI) was obtained by directly measuring the X, Y and Z tristimulus coordinates on pellets using a tristimulus colorimeter capable of assessing the deviation of an object color from a pre-set standard white towards yellow in a dominant wavelength range between 570 and 580 nm. The geometric characteristics of the apparatus allowed perpendicular viewing of the light reflected by two light rays that hit the specimen at 45°, at an angle of 90° to each other, coming from a “Source C” according to CIE standard. After calibration, the glass container was filled with the pellets to be tested and the X, Y, Z coordinates were obtained to calculate the yellowness index according to the following equation:

YI=100*(1.274976795*X−1.058398178*Z)/Y

### EXAMPLES

### General Procedure for the Polymerization of Propylene

A 4-liter steel autoclave equipped with a stirrer, pressure gauge, thermometer, catalyst feeding system, monomer feeding lines and thermostatic jacket, was purged with a nitrogen flow at 70° C. for one hour. A suspension containing 75 ml of anhydrous hexane, 0.6 g of triethyl aluminum (AlEt₃, 5.3 mmol) and 0.006 to 0.010 g of solid catalyst component, pre-contacted for 5 minutes with 10 wt % of total AlEt₃ and an amount of dicyclopentyldimethoxysilane, thereby providing a molar ratio between Al/dicyclopentyldimethoxysilane of 20 in a glass-pot, was charged. The autoclave was closed, and hydrogen was added (4500 cc). Then, under stirring, 1.2 kg of liquid propylene was fed. The temperature was raised to 70° C. in about 10 minutes and the polymerization was carried out at this temperature for 2 hours. At the end of the polymerization, the non-reacted propylene was removed; the polymer was recovered and dried at 70° C. under vacuum for 3 hours. The resulting polymer was weighed and characterized.

General Procedure for the Preparation of MgCl₂.(EtOH)m Adducts.

An amount of microspheroidal MgCl₂.2.8C₂H₅OH was prepared according to the method described in Example 2 of U.S. Pat. No. 4,399,054. The resulting adduct had an average particle size of 25 μm.

### Example 1 (Comparative)

### Preparation of a 9,9-bis(methoxymethyl)fluorene Containing Solid Catalyst Component

Into a 2.0 L round bottom glass reactor, equipped with mechanical stirrer, cooler and thermometer, 1.0 L of TiCl₄ was introduced at room temperature under a nitrogen atmosphere. After cooling to −5° C., while stirring, 13.2 g of microspheroidal complex of MgCl₂ and EtOH were introduced. The temperature was then raised from −5° C. to 40° C., and when this temperature was reached, an amount of 9,9-bis(methoxymethyl)fluorene, used as an internal electron donor, was introduced, thereby producing a Mg/9,9-bis(methoxymethyl)fluorene molar ratio of 6.

At the end of the addition, the temperature was increased to 100° C. and maintained at this value for 30 minutes. Thereafter, stirring was stopped, and the solid product settled. Then the supernatant liquid was siphoned off, leaving a fixed residual volume in the reactor of 300 cm³, while maintaining the temperature at 75° C. After the supernatant was removed, fresh TiCl₄ and an additional amount of donor were added, thereby providing a Mg/9,9-bis(methoxymethyl)fluorene molar ratio of 20. The whole slurry mixture was then heated at 109° C. and kept at this temperature for 30 minutes. The stirring was interrupted; the solid product settled, and the supernatant liquid was siphoned off, while maintaining the temperature at 109° C. A third treatment in fresh TiCl₄ (1 L of total volume) was repeated, keeping the mixture under agitation at 109° C. for 15 minutes, and then the supernatant liquid was siphoned off.

The solid was washed with anhydrous i-hexane five times (5×1.0 L) at 50° C. and one time (1.01) at room temperature.

The solid was finally dried under vacuum, weighed, and analyzed.

Catalyst composition: Mg=12.5 wt %; Ti=3.7 wt %; I.D.=20.7 wt %.

The catalyst was used in the polymerization of propylene. Results are shown in Table 1.

### Example 2

### Preparation of the Solid Catalyst Component/Coloring Agent Hydrocarbon Slurry

Into a 2-liter recipient, containing one liter of n-hexane, were introduced 40 grams of the catalyst component prepared as described in Example 1 and 17 grams of Cu-phthalocyanine. The slurry was stirred for at 350 rpm for 240 minutes and then stored at room temperature for 24 hours. After that time, the slurry was tested in the polymerization of propylene. Results are shown in Table 1.

### Examples 3-4

A series of polymerization examples was carried out according to the polymerization procedure previously described, with the difference that the amount of Cu-Phthalocyanine reported in Table 1 was added to the pre-contacting glass-pot before being added to the polymerization reactor.

### Examples 5-6

A series of polymerization examples was carried out as described in examples 3-4 with the difference that Ultramarine Blue was used instead of Cu-phthalocyanine.

### Comparative Example 7

The catalyst was prepared, and polymerization carried out, in analogy with Example 2 with the difference that the catalyst component and the pigment were dry blended. Results are shown in Table 1.

### Comparative Example 8-9

The same procedure described in Comparative Example 7 was followed with the difference that Ultramarine Blue, in the amount reported in Table 1, was used instead of Cu-Phthalocyanine.

TABLE 1

| | | POLYMERIZATION | | | | |
|---|---|---|---|---|---|---|
| | PIGMENT/CAT | | | Yellow | Bulk | Pigment |
| EXAM- | MIXTURE | Activity | XI | Index | Density | in PP |
| PLE | Weight ratio | Kg/gcat | % wt | — | g/cm³ | ppm |
| C1 | — | 46 | 98.6 | 1.4 | 0.48 | — |
| 2 | 0.02:1 | 44 | 98.6 | −0.9 | 0.51 | 0.4 |
| 3 | 0.3:1 | 50 | 98.4 | −28 | 0.46 | 5 |
| 4 | 0.8:1 | 48 | 98.6 | −85 | 0.47 | 22 |
| 5 | 0.4:1 | 55 | 98.8 | −2.5 | 0.47 | 10 |
| 6 | 2.5:1 | 53 | 98.7 | −7.8 | 0.45 | 26 |
| C7 | 0.2:1 | 14 | 98.3 | −27 | 0.390 | 10 |
| C8 | 0.2:1 | 25 | 98.6 | 1.5 | 0.44 | 9 |
| C9 | 0.5:1 | 27 | 97.8 | −7.7 | 0.47 | 75 |

What is claimed is:

1. A process for the preparation of a propylene polymer containing a coloring agent in an amount ranging from 0.2 to 30 ppm referred to the weight of propylene polymer, comprising the steps of:
a) providing a solid ZN catalyst component comprising Mg, Ti, halogen and an internal electron donor compound, wherein the Ti being in an amount ranging from 0.1 to 10% of the total weight of solid catalyst component;
b) providing a coloring agent comprising at least a pigment;
c) mixing the ZN catalyst particles and the coloring agent in a liquid hydrocarbon medium, thereby obtaining a slurry; and
d) feeding the slurry to a polymerization reactor and subjecting the reactor to polymerization conditions, thereby yielding the propylene polymer.

2. The process according to claim 1, wherein the ZN catalyst has a regular morphology and is obtained by reacting Ti-halides with precursors comprising adducts of formula MgCl₂(R¹OH)ₙ where R¹ is a C₁-C₈ alkyl group, and n is from 2 to 6.

3. The process according to claim 1, wherein, in the ZN catalyst component the amount of Mg ranges from 8 to 30% and the amount of Ti ranges from 0.5 to 8% wt with respect to the total weight of solid catalyst component.

4. The process according to claim 3, wherein the electron donor compound is selected from esters, ethers, amines, silanes, carbamates and ketones or mixtures thereof.

5. The process according to claim 4, wherein the electron donor compound is selected from the group consisting of 1,3-diethers of formula (I) 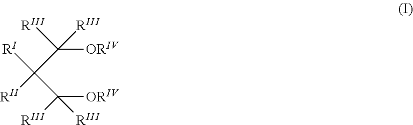
where R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups cannot be hydrogen.

6. The process according to claim 4, wherein the final amount of electron donor compound in the solid catalyst component ranges from 0.5 to 30% by weight.

7. The process according to claim 1, wherein the pigment is black or blue.

8. The process according to claim 7, wherein the pigment is Cu-Phthalocyanine.

9. The process according to claim 7, wherein the pigment is inorganic and selected from the group consisting of Ultramarine Blue and Carbon Black.

10. The process according to claim 1, wherein the coloring agent is used in an amount such that the weight ratio coloring agent of step b)/catalyst component of step a) ranges from 0.005 to 5.

11. The process according to claim 1, wherein the solid catalyst component of step a) and the coloring agent of step b) are separately contacted with a liquid inert hydrocarbon, at a temperature below about 60° C. before being introduced into the polymerization reactor.

12. The process according to claim 1, wherein, before being introduced into the reactor the solid catalyst component of step a), the coloring agent of step b), are contacted in a single step with an alkyl-Al compound, and optionally with an external donor, in the presence of a liquid inert hydrocarbon.

13. The process according to claim 12, wherein the alkyl-Al compound is the group consisting of trialkyl aluminum compounds.

14. The process according to claim 12, wherein the external donor is present and selected from silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms.

15. The process according to claim 1, wherein the amount of coloring agent in the final propylene polymer ranges from 0.3 to 28 ppm.
